(19) United States
(12) Patent Application Publication
(10) Pub. No.: US 2024/0293948 A1
(43) Pub. Date: Sep. 5, 2024

(54) CUTTING APPARATUS AND ITS HOLDING DEVICE

(71) Applicant: NATIONAL CENTRAL UNIVERSITY, Taoyuan City (TW)

(72) Inventor: YUN-CHI CHUNG, Taoyuan City (TW)

(21) Appl. No.: 18/326,736

(22) Filed: May 31, 2023

(30) Foreign Application Priority Data
Mar. 2, 2023 (TW) 112107434

(51) Int. Cl. B26D 7/02

(52) U.S. Cl. CPC B26D 7/025; B28D 5/0082

(57) ABSTRACT

A holding device applied to a cutting apparatus to hold an object to be cut includes a holding element and a plurality of damping particles. The holding element is used for holding the object to be cut, and the holding element includes at least one accommodating cavity. Each accommodating cavity extends inward from the outer surface of the holding element to form an accommodating space. The plurality of damping particles is placed in at least one accommodating cavity. During the cutting process of the object to be cut, the plurality of damping particles generates collision and friction with each other or with the cavity wall of the accommodating cavity to reduce the vibration generated by the object to be cut, thereby reducing the surface warpage of a plurality of small-volume objects formed after cutting the object to be cut.

### FIELD OF THE INVENTION

The present invention relates to a holding device, specifically one that is applied to cutting apparatuses with a vibration offset function. The present invention further includes a cutting apparatus to which the holding device is applied.

### BACKGROUND OF THE INVENTION

In the manufacturing process of many components, there are parts with a large volume that need to be cut into small pieces for further processing. Such a cutting process is usually performed by having cutting apparatuses (such as cutting knives and saws) displacing the large-volume objects back and forth or repeatedly in a cycle. However, when the cutting apparatuses contact the large-volume objects during the cutting processes, it is very likely to induce vibrations of the large-volume objects. Accordingly, the small-volume objects produced after the cutting process would have rough and unsmooth surfaces. For the components that require high precision (such as ingots), when the vibration problem occurs during the cutting process, the surfaces of the small-volume objects produced after the cutting process (such as the wafer slices or dies) would be affected greatly, leading to more manufacturing costs and extra loss of the materials.

### SUMMARY OF THE INVENTION

An objective of the present invention is to provide a holding device that is applied to cutting apparatuses and that offsets and reduces the vibration during the operation.

To achieve the objective mentioned above, the holding device includes a holding element and a plurality of damping particles. The holding element is for fixedly holding an object to be cut and includes at least one accommodating cavity, each of which forms an accommodating space extending inwardly from an external surface of the holding element. The plurality of damping particles is filled into at least one accommodating cavity. Wherein the plurality of damping particles performs collision and friction between each other or with a cavity wall of at least one accommodating cavity to attenuate vibrations generated from the object during the cutting process, thereby reducing the surface warpage of a plurality of small-volume objects produced after the object is cut.

In an embodiment, the holding element has a first surface and a second surface arranged opposite to the first surface, and each accommodating cavity extends toward the second surface along a direction substantially perpendicular to the axial direction of the first surface.

In an embodiment, the axial direction of the first surface is substantially perpendicular to the cutting direction of the object to be cut.

In an embodiment, when there is one accommodating cavity, it is arranged at the center of the holding element.

In an embodiment, when there are plural accommodating cavities, they are arranged symmetrically on the center area of the holding element.

In an embodiment, the plurality of damping particles is filled into at least one of the accommodating cavities.

In an embodiment, at least one accommodating cavity is in a cylindrical, rectangular, or elliptical column shape.

In an embodiment, at least one accommodating cavity is either a blind hole or a through hole.

In an embodiment, the plurality of damping particles is made from metals, alloys, or plastic materials.

In an embodiment, the plurality of damping particles has a solid or hollow structure.

In an embodiment, the plurality of damping particles is spherical or non-spherical.

With the plurality of damping particles, the holding device is able to offset and reduce the vibration produced by the object to be cut during the cutting process and to fixedly hold the object, thereby reducing the surface warpage of a plurality of small-volume objects produced after the cutting process. On the other hand, with the damping particles, the center of mass of the holding element can be kept at the central position so that the holding element is steadier when it's moving.

Another objective of the present invention is to provide a cutting apparatus to which the holding device is applied. The cutting apparatus includes the aforementioned holding device, a driving device, and a cutting device. The holding device holds the object to be cut. The driving device is connected to the holding device, driving the holding device to move towards or away from the cutting device. The cutting device is arranged correspondingly to the holding device, displacing along a cutting direction on the object back and forth or repeatedly in a cycle, in order to perform the cutting process.

### BRIEF DESCRIPTION OF THE DRAWINGS

FIG. 1 is a schematic diagram of the present invention, illustrating a holding device thereof;

FIG. 2 is a sectional view of the parts of the holding device;

FIG. 3 is a schematic diagram of the holding device in another embodiment; and

FIG. 4 is a schematic diagram of the present invention, illustrating a cutting apparatus thereof.

### DETAILED DESCRIPTION OF THE PREFERRED EMBODIMENTS

In order to fully comprehend the objectives, features and efficacy of the present invention, a detailed description is described by the following substantial embodiments in conjunction with the accompanying drawings. The description is stated below.

The description of unit, element and component in the present invention uses “one”, “a”, or “an”. The way mentioned above is for convenience, and for general meaning of the category of the present invention. Therefore, the description should be understood as “include one”, or “at least one”, and include the singular and plural forms at the same time unless obvious meaning.

The description of ordinal numbers for elements or components in the present invention are mainly for similar parts or structures and do not indicate any order in sequence in time or space arrangement. Under certain conditions or combinations, the elements or components described with ordinal numbers are interchangeable within the scopes of the present invention.

The description of comprise, have, include, contain, or another similar semantics has a non-exclusive meaning. For example, an element, structure, product, or device containing multi requirements is not limited in the list of the content, but includes another inherent requirement of an element, structure, product, or device not explicitly listed in the content. In addition, the term “or” has an inclusive meaning instead of an exclusive one.

The present invention has a holding device applied to cutting apparatuses like wire cutting apparatus, cutting knives, and saws, but the present invention is not limited to such applications. In the following embodiments, a wire-cutting apparatus is taken as an example. It has displaceable wires (which are singular or multiple and made from metals or alloys, or even coated by cutting particles with greater hardness such as diamonds) serving as the cutting components. The wires displace along at least one axial direction or in repeating cycles to perform cutting on the objects to be cut and cut the objects with large volumes into multiple parts with small volumes.

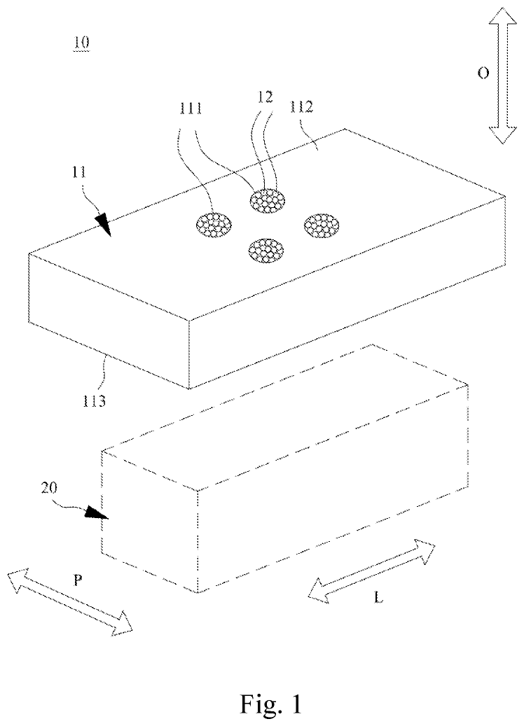

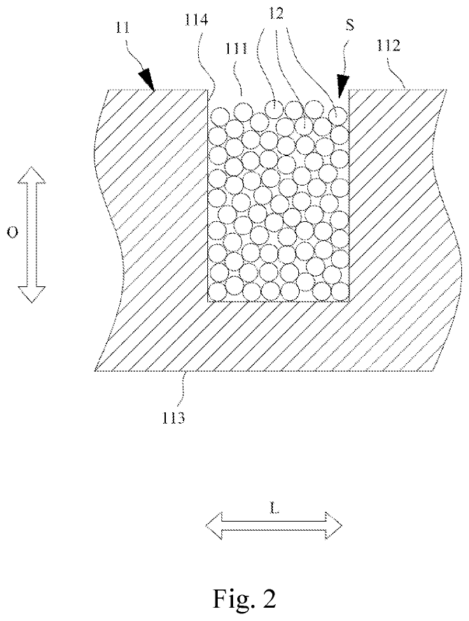

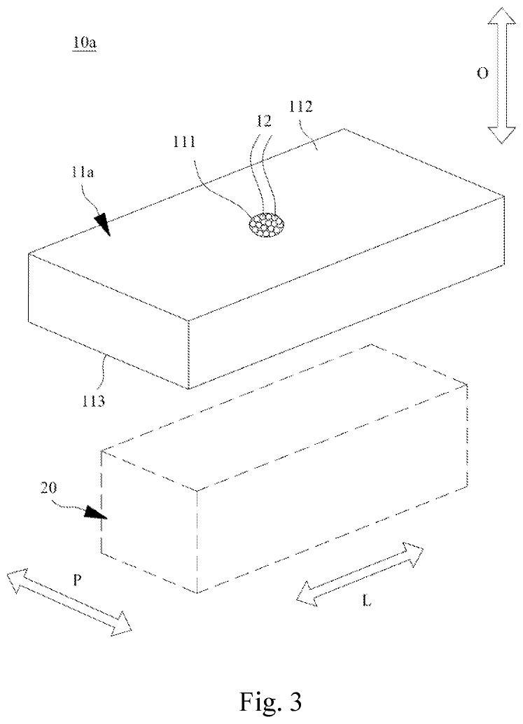

Referring to FIGS. 1-3, FIG. 1 is a schematic diagram of the holding device, FIG. 2 is a sectional view of part of the holding device; and FIG. 3 is another schematic diagram of the holding device in another embodiment. As shown in FIGS. 1 and 2, the holding device 10 includes a holding element 11 and a plurality of damping particles 12. The holding element 11 fixedly holds an object to be cut 20 (shown in broken lines in FIG. 1). For instance, when the holding device 10 is applied to a wafer-cutting machine, the object to be cut 20 is an ingot with a large volume, and a plurality of wafer slices with a small volume is produced after the ingot is cut. But the present invention is not limited to such application. The holding element 11 fixedly holds the object to be cut via its own structure (like a jaw gripper) or via additional adhesives. In the wafer-cutting machine application, the holding element 11 has the ingot adhered by an adhesive (like epoxy resin) first; after the ingot is cut, a certain solvent is applied to remove the adhesive and obtain the wafer slices.

As shown in FIG. 1, the holding element 11 can be in a rectangular structure that is symmetrical and positioned at the center of the holding element 11, but the present invention is not limited to such application. The holding element 11 can be designed in other shapes or an asymmetrical structure in 3-dimensions. The structure and size of the holding element 11 are flexible and adjustable as well. In addition, the holding element 11 can be made from rigid materials such as metals, stones, plastics, or other materials with similar characteristics, but the present invention is not limited to such application.

According to the present invention, the holding element 11 includes at least one accommodating cavity 111, the number and location of which are both adjustable. There can be only one or multiple accommodating cavities 111. When there is one accommodating cavity 111, it is arranged at the center of the holding element 11 as illustrated in FIG. 3, but the present invention is not limited to such application. The single accommodating cavity 111 can be arranged at other positions far from the center of the holding element 11 as needed. When there are plural accommodating cavities 11, they are arranged symmetrically on the center area of the holding element 11. As illustrated in FIG. 1, in this embodiment there are four accommodating cavities 111 arranged to be surrounding the central area of the holding element 11 symmetrically, and the accommodating cavities 11 are all in the same size; but the present invention is not limited to such application. The plural accommodating cavities 111 can be arranged in symmetry or asymmetry based on the center of the holding element 11, and/or have different sizes.

As shown in FIGS. 1 and 2, a structural design of the accommodating cavities 111 is that each of which forms an accommodating space S extending inwardly from an external surface of the holding element 11. In an embodiment, the holding element 11 has a first surface 112 and a second surface 113 arranged opposite to the first surface 112, and each accommodating cavity 111 extends toward the second surface 113 along a direction substantially perpendicular to an axial direction O of the first surface 112; The axial direction O of the first surface 112 herein is substantially perpendicular to a cutting direction P of the object 20 to be cut and to a length direction L of the object 20. That is, the cutting direction P of the object 20 and the length direction L thereof are parallel with the first surface 112 and the second surface 113 thereof. In an embodiment, each accommodating cavity 111 is in a cylindrical, rectangular, or elliptical column shape, but the present invention is not limited to such application. They can be arranged in other shapes as well.

On the other hand, the extension of each accommodating cavity 111 along the axial direction O of the first surface 112 is adjustable as needed as well. For instance, as shown in FIG. 2, each accommodating cavity 111 can be a blind hole, that is, the accommodating cavity 111 extends along the axial direction O toward the second surface 113, but does not reach the second surface 113. However, the present invention is not limited to such application. Each accommodating cavity 111 can also extend toward and reach the second surface 113 along the axial direction O, forming a through hole. The opening area of the accommodating cavities 111 can be covered by one or more covering pieces in accordance with the different designs of blind holes or through holes.

The plurality of damping particles 12 is filled in at least one accommodating cavity 111. The damping particles 12 are made from metals, alloys, or plastic materials. For instance, the damping particle 12 can be made from tungsten or steel; or when they are made from plastic materials, the particles are flexible due to the characteristic of the raw material. With different designs or requirements, the plurality of damping particles 12 has a solid or hollow structure; or they are spherical or non-spherical. In an embodiment, the damping particles 12 can be filled into at least one of the accommodating cavities 111. By adjusting the total amount and locations of the accommodating cavities where the damping particles 12 are filled, the center of mass of the holding element 11 can be remained at the center thereof, so as to keep the structure and status of the holding element 11 stable during the cutting process.

In this embodiment, the damping particles 12 are not fully filled into the accommodating cavities 111; in other words, the accommodating cavities 111 still have a certain space after the damping particles 12 are filled therein. Thereby the damping particles 12 can move around within the accommodating cavities 111 as the holding element 11 is moved, allowing collisions and frictions to occur between the damping particles 12 and a cavity wall 114 of the accommodating cavities 111. However, the damping particles 12 can be arranged to be fully filled in the accommodating cavities 111 as required or needed.

An embodiment of the holding device 10 is described hereafter in accordance with FIG. 1. Firstly, the object 20 to be cut is fixedly held by the holding element 11 of the holding device 10 and the holding element 11 can be driven by a driving device of a cutting apparatus, displacing the object 20 along the axial direction O toward the cutting apparatus. In the cutting process, as the cutting apparatus contacts the object 20 and starts cutting it along the cutting direction P back and forth or cutting it repeatedly in a cycle pattern, the object 20 would vibrate together with the holding element 11. The vibration includes one along the cutting direction P, one along the axial direction O and/or one along the length direction L of the object 20 (i.e., a direction perpendicular to the cutting direction P and the axial direction O). With the arrangement of having the accommodating cavities 111 extending toward the axial direction O, the cavity walls 114 of the accommodating cavities 111 are majorly perpendicular to the cutting direction P and the length direction L of the object 20. When the vibrations occur, the collision and friction between the plurality of damping particles 12 and/or between the damping particles 12 and the cavity walls 114 of the accommodating cavities 111 reduce the vibrations from the object along the cutting direction P, the axial direction O and/or the length direction L of the object 20, especially the last. Thereby the holding device 10 is able to hold the object 20 steady during the cutting process and reduce the surface warpage of a plurality of small-volume objects produced after the cutting process.

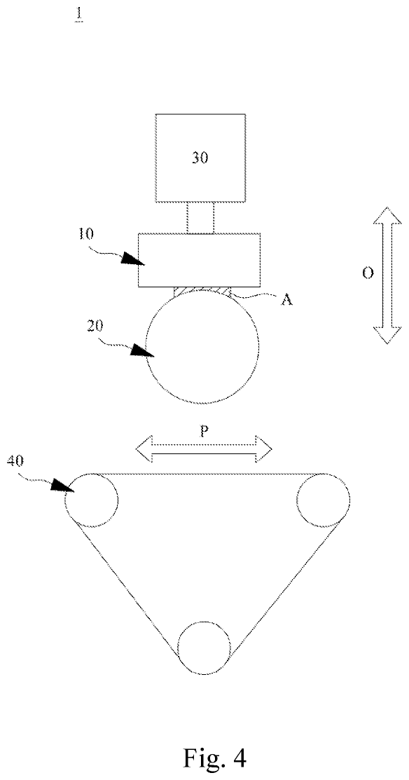

FIG. 4 is a schematic diagram of cutting apparatus 1 of the present invention. As shown in FIG. 4, the present invention further includes the cutting apparatus 1 to perform the cutting to the object 20 to be cut. The cutting apparatus 1 includes the holding device 10 as described above, a driving device 30, and a cutting device 40. The holding device 10 holds the object 20 and can have adhesives A further applied for adhering the object 20 fixedly. The driving device 30 is connected to the holding device 10 to drive it for displacing along the axial direction O towards or away from the cutting device 40. The cutting device 40 is arranged correspondingly to the holding device 10. In FIG. 4, the cutting device 40 is disposed right underneath the holding device 10 for facing the object 20 in alignment. The cutting device 40 is thereby driven to displace along the cutting direction P on the object 20 back and forth or repeatedly in a cycle, so as to perform the cutting on the object 20 fixedly held by the holding device 10. The cutting device 40 may comprise singular or plural wire cutting components, cutting knives components or saws.

With the structures disclosed above, when the cutting apparatus 1 is performing the cutting process, the driving device 30 drives the holding device 10 moving toward the cutting device 40 along the axial direction O in order to cut the object 20. When the cutting apparatus 1 completes the cutting process, the driving device 30 drives the holding device 10 moving away from the cutting device 40 along the axial direction O in order to take the object 20 away from the cutting device 40. Then the pieces of the object 20 after cutting are removed therefrom.

The present invention is disclosed by the preferred embodiments in the aforementioned description; however, it is contemplated for one skilled at the art that the embodiments are applied only for an illustration of the present invention, rather than being interpreted as a limitation for the scope of the present invention. It should be noted that the various substantial alternation or replacements equivalent to these embodiments shall be considered as being covered within the scope of the present invention. Therefore, the claims define the protection scope of the present invention.

1. A holding device applied to a cutting apparatus for holding an object to be cut, said holding device comprising: a holding element for holding said object fixedly, including at least one accommodating cavity, each of which forming an accommodating space extending inwardly from an external surface of said holding element; and a plurality of damping particles filled in at least one accommodating cavity; wherein the plurality of damping particles performs collision and friction between each other or with a cavity wall of at least one accommodating cavity to reduce vibrations generated from the object during the cutting process and thereby reduce surface warpage of a plurality of small-volume objects produced after the cutting process.

2. The holding device defined in claim 1, wherein the holding element has a first surface and a second surface arranged opposite to the first surface, and each accommodating cavity extends toward the second surface along a direction substantially perpendicular to an axial direction of the first surface.

3. The holding device defined in claim 2, wherein the axial direction of the first surface is substantially perpendicular to the cutting direction of the object to be cut.

4. The holding device defined in claim 1, wherein when there is one accommodating cavity, it is arranged at the center of the holding element.

5. The holding device defined in claim 1, wherein plural accommodating cavities are arranged symmetrically on a center area of the holding element.

6. The holding device defined in claim 5, wherein the plurality of damping particles is filled into at least one of the accommodating cavities.

7. The holding device defined in claim 1, wherein at least one accommodating cavity is in a cylindrical, rectangular, or elliptical column shape.

8. The holding device defined in claim 7, wherein at least one accommodating cavity is either a blind hole or a through hole.

9. The holding device defined in claim 1, wherein the plurality of damping particles is made from metals, alloys or plastic materials.

10. The holding device defined in claim 1, wherein the plurality of damping particles has a solid or hollow structure.

11. The holding device defined in claim 1, wherein the plurality of damping particles is spherical or non-spherical.

12. A cutting apparatus that performs cutting to an object to be cut, comprising: a holding device defined in claim 1 for holding said object to be cut; a driving device connected to said holding device, driving said holding device to move towards or away from a cutting device; and said cutting device arranged correspondingly to said holding device, displacing along a cutting direction on said object back and forth or repeatedly in a cycle, in order to perform the cutting process.
